(19) United States
(12) Patent Application Publication
(10) Pub. No.: US 2021/0189687 A1
(43) Pub. Date: Jun. 24, 2021

(54) ROTARY DRIVE SYSTEM AND HYDRAULIC EXCAVATOR

(71) Applicant: Komatsu Ltd., Tokyo (JP)

(72) Inventors: Akira Minamiura, Tokyo (JP); Masahiko Ishiyama, Tokyo (JP); Naoyuki Iwamoto, Tokyo (JP); Teiichirou Chiba, Tokyo (JP)

(21) Appl. No.: 16/761,305

(22) PCT Filed: Oct. 23, 2018
(86) PCT No.: PCT/JP2018/039399

§ 371 Date: May 4, 2020

(30) Foreign Application Priority Data
Jan. 31, 2018 (JP) 2018-015909

(51) Int. Cl. E02F 9/12; F16H 57/04; F16H 57/021; F16H 57/10

(52) U.S. Cl. CPC E02F 9/126; E02F 9/128; F16H 57/0409; F16H 57/0424; F16H 57/043; F16H 57/0441; F16H 2057/02082; F16H 57/0471; F16H 57/0476; F16H 57/0486; F16H 57/021; F16H 57/10; F16H 57/045

(57) ABSTRACT

A rotary drive system includes an electric motor, a speed reducer, and a lubricating oil-circulating unit. The electric motor has an electric motor casing forming a first accommodating space and a communication hole communicating downward. The speed reducer has a speed reducer casing forming a second accommodating space communicating with the first accommodating space through the communication hole. The lubricating oil-circulating unit has a lubricating oil flow path and a lubricating oil pump. The lubricating oil flow path connects the first accommodating space and the second accommodating space at the outside. The lubricating oil pump pumps lubricating oil from the second accommodating space side to the first accommodating space side.

### TECHNICAL FIELD

The present invention relates to a rotary drive system and a hydraulic excavator. This application claims priority based on Japanese Patent Application No. 2018-015909, filed on Jan. 31, 2018, in Japan, the contents of which are incorporated herein by reference.

### BACKGROUND TECHNOLOGY

Patent Document 1 describes a rotary drive system in which an electric motor and a speed reducer for reducing the speed of the rotation of the electric motor are integrally provided. The speed reducer includes a plurality of stages of planetary gear mechanisms as transmission portions accommodated in the speed reducer casing.

Lubricating oil is stored in the space in the speed reducer casing, and each planetary gear mechanism is immersed in the lubricating oil.

On the other hand, in order to remove heat generated from the rotor and stator during operation of the electric motor, cooling oil is supplied to the inside of the electric motor casing. A lower portion of a space in the electric motor casing is used as a tank in which the cooling oil is stored. The cooling oil discharged from the electric motor is cooled at the outside thereof and then is again supplied into the electric motor casing.

### PRIOR ART DOCUMENT

### Patent Document

### [Patent Document 1] Japanese Unexamined Patent Application Publication No. 2009-79627.

### SUMMARY OF THE INVENTION

### Problems to be Solved by the Invention

In the rotary drive system described above, some of the cooling oil is stored in part of the electric motor casing while storing the lubricating oil in the speed reducer casing. That is, since there is a tank for storing lubricating oil or cooling oil in each of the speed reducer and the motor, the size of the apparatus may be increased.

Further, it is necessary to individually manage the lubricating oil of the speed reducer and the cooling oil of the electric motor, and for example, it is necessary to provide an oil inspection pipe for inspecting the oil quantity and a supply port for supplying the lubricating oil separately. Therefore, there is an increase in cost.

The present invention has been made in view of such problems, and it is an object to provide a rotary drive system and a hydraulic excavator using the same which are capable of reducing cost while achieving compactness.

### Means for Solving the Problem

An aspect of the present invention provides a rotary drive system, including: an electric motor including a rotary shaft provided so as to be rotatable about an axis extending in a vertical direction, a rotor core fixed to an outer peripheral surface of the rotary shaft, a stator surrounding the rotor core from the outer peripheral side of the rotor core, and an electric motor casing forming a first accommodating space that accommodates the rotary shaft, the rotor core and the stator so that a lower portion of the rotary shaft projects downward, and forming a communication hole communicating downward, an output shaft provided so as to be rotatable about the axis below the rotary shaft; a transmission portion in which a rotation of the rotary shaft is reduced in speed and is transmitted to the output shaft; a speed reducer having a speed reducer casing that accommodates the output shaft and the transmission portion so as to project downward a lower portion of the output shaft and forms a second accommodating space communicating with the first accommodating space through the communication hole; and a lubricating oil-circulating unit including a lubricating oil flow path that connects the first accommodating space and the second accommodating space, and a lubricating oil pump that is provided in the lubricating oil flow path and is configured to pump a lubricating oil from the second accommodating space side to the first accommodating space side.

According to the rotary drive system having the above structure, lubricating oil supplied into the electric motor casing is introduced into the speed reducer casing through the communication hole. Therefore, it is possible to supply again the lubricating oil in the speed reducer casing to the electric motor by the lubricating oil-circulating unit.

Accordingly, it is possible to consistently carry out cooling of the electric motor and lubricating of the speed reducer through a single lubricating oil-circulating unit. Therefore, a tank for storing lubricating oil in the electric motor is not necessary.

Further, it is not necessary to separately manage the amount of oil of the speed reducer and the electric motor.

### BRIEF DESCRIPTION OF DRAWINGS

FIG. 1 is a side view of a hydraulic excavator provided with a rotary drive system related to an embodiment of the present invention.

FIG. 2 is a plan view of the hydraulic excavator provided with the rotary drive system according to the embodiment of the present invention.

FIG. 3 is a schematic diagram showing an outline of the rotary drive system relating to the embodiment of the present invention.

FIG. 4 is a longitudinal sectional view of the rotary drive device in the rotary drive system according to the embodiment of the present invention.

FIG. 5 is an enlarged view of the electric motor in FIG. 4.

FIG. 6 is a vertical sectional view of the electric motor of the rotary drive system according to the embodiment of the present invention at a position different from that shown in FIG. 4.

FIG. 7 is an enlarged view of the speed reducer in FIG. 4.

FIG. 8 is a partially enlarged view of the reducer in FIG. 7, showing the liquid level of lubricating oil at the time of stopping the operation.

FIG. 9 is a partially enlarged view of a speed reducer in FIG. 7, showing a liquid level of lubricating oil during operation.

### MODE FOR CARRYING OUT THE INVENTION

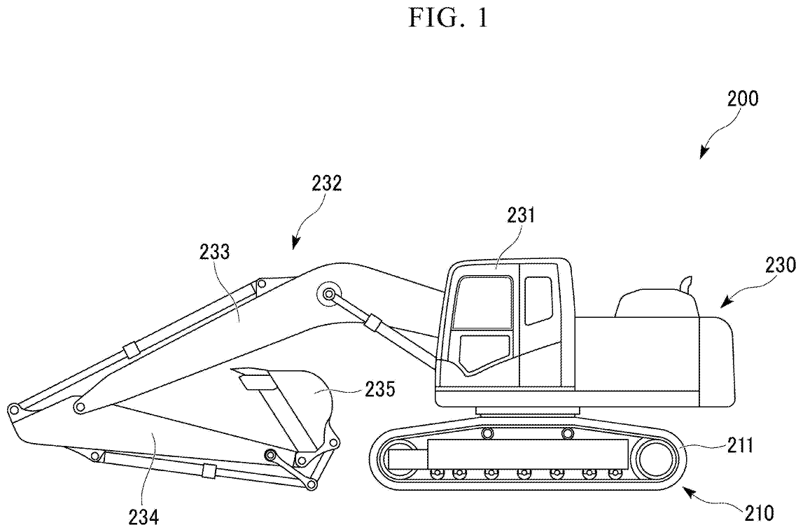

The present invention will be described in detail below with reference to FIG. 1 to FIG. 9.

### <Work Machine>

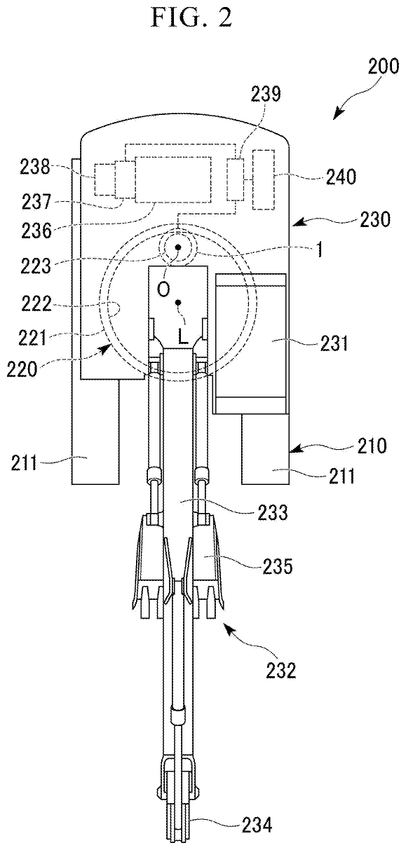

As shown in FIGS. 1 and 2, a hydraulic excavator 200 as a work machine includes an undercarriage 210, a swing circle 220, and an upper swing body 230. In the following description, the direction in which gravity is applied in a state in which the work machine is placed on the horizontal surface is referred to as a “vertical direction”. Further, the front of an operator's seat in a cab 231 described later is simply referred to as “forward”, and the rear of the operator's seat is simply referred to as “rearward”.

The undercarriage 210 includes a pair of right and left crawler belts 211, 211 and the crawler belts 211,211 are driven by a travel-use hydraulic motor (not shown) thereby travelling the hydraulic excavator 200.

The swing circle 220 is a member for connecting the undercarriage 210 and the upper swing body 230, and includes an outer race 221, an inner race 222, and a swing pinion 223. The outer race 221 is supported by the undercarriage 210 and has an annular shape centered on a swing axis L extending in correspondence with the vertical direction. The inner race 222 is an annular member that is coaxial with the outer race 221, and is disposed inside the outer race 221. The inner race 222 is supported so as to be relatively rotatable about the swing axis L with respect to the outer race 221. The swing pinion 223 meshes with inner teeth of the inner race 222, and the inner race 222 rotates relative to the outer race 221 by a rotation of the swing pinion 223.

The upper swing body 230 is disposed so as to be capable of swinging about the swing axis L with respect to the undercarriage 210 by being supported by the inner race 222. The upper swing body 230 includes a cab 231, a work equipment 232, an engine 236 provided rearward of the cab and the work equipment, a generator motor 237, a hydraulic pump 238, an inverter 239, a capacitor 240, and a rotary drive system 1.

The cab 231 is disposed forward and on the left side of the upper swing body 230, and is provided with an operator's seat. The work equipment 232 is provided so as to extend forward the upper swing body 230, and has a boom 233, an arm 234, and a bucket 235.

The work equipment 232 performs various operations such as excavation by driving the boom 233, the arm 234, and the bucket 235 by respective hydraulic cylinders (not shown).

Shafts of the engine 236 and the generator motor 237 are connected to each other. The generator motor 237 is driven by the engine 236 to generate electric power. Rotary shafts of the generator motor 237 and the hydraulic pump 238 are connected to each other. The hydraulic pump 238 is driven by the engine 236. Hydraulic pressure generated by driving the hydraulic pump 238 drives the aforementioned travel-use hydraulic motor and each of the hydraulic cylinders. In addition, the connection method for the engine 236, the generator motor 237, and the hydraulic pump 238 is not limited to the present embodiment and can be in an arbitrary known method.

The generator motor 237, the capacitor 240 and the rotary drive system 1 are electrically connected to each other via the inverter 239. In addition, another storage device such as a lithium ion battery, or the like, may be used instead of the capacitor 240.

The rotary drive system 1 is arranged in a vertical placed state such that an axis O as the center of rotation coincides with the vertical direction. The output of the rotary drive system 1 is transmitted to a swing pinion 223 that meshes with the inner teeth of the inner race 222.

The hydraulic excavator 200 drives the rotary drive system 1 by electric power generated by the generator motor 237 or by electric power from the capacitor 240. A driving force of the rotary drive system 1 is transmitted to the inner race 222 via the swing pinion 223. As a result, the inner race 222 rotates relative to the outer race 221, thereby swinging the upper swing body 230.

When the swing of the upper swing body 230 is decelerated, the rotary drive system 1 functions as a generator to generate electric power as regenerative energy. This electric power is stored in the capacitor 240 via the inverter 239. The electric power stored in the capacitor 240 is supplied to the generator motor 237 at the time of accelerating the engine 236. By the generator motor 237 being driven by the electric power of the capacitor, the generator motor 237 assists an output of the engine 236.

### <Rotary Drive System>

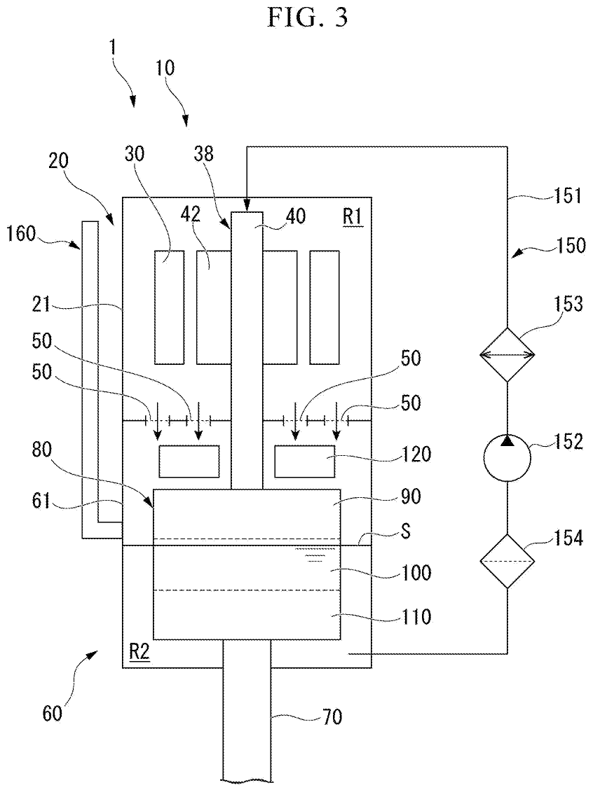

As shown in FIG. 3, the rotary drive system 1 includes a rotary drive device 10, an oil inspection unit 160, and a lubricating oil-circulating unit 150.

### <Rotary Drive Device>

The rotary drive device 10 includes an electric motor 20 and a speed reducer 60 provided integrally with the electric motor 20. The speed reducer 60 is disposed below the electric motor 20.

### <Electric Motor>

As shown in FIGS. 3 to 6, the electric motor 20 includes an electric motor casing 21, a stator 30, and a rotor 38.

### <Electric Motor Casing>

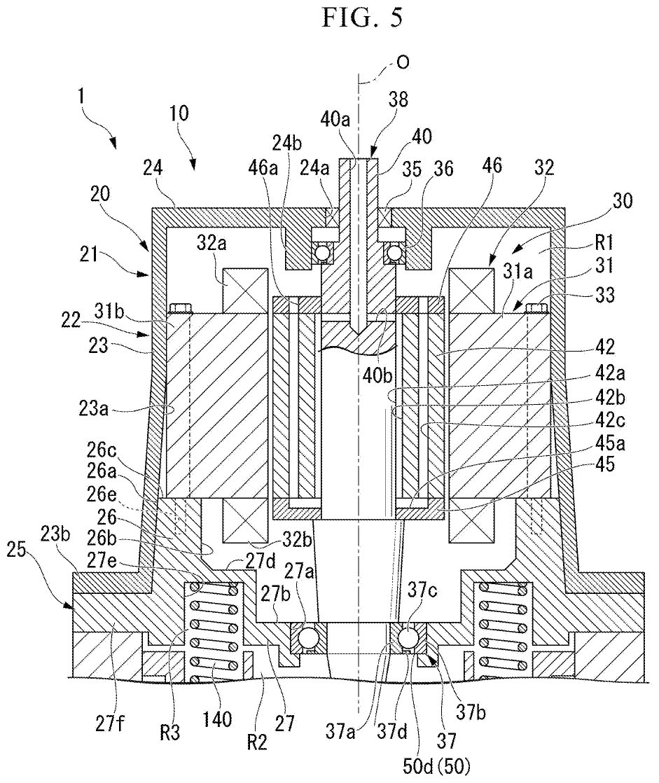

As shown in FIG. 5, the electric motor casing 21 is a member that forms an outer shape of the electric motor 20. The motor casing 21 has an upper casing 22 and a lower casing 25.

The upper casing 22 has a bottomed cylindrical shape having an upper cylindrical portion 23 that has a cylindrical shape extending in the vertical direction (axial O direction) and an upper bottom portion 24 that closes an upper portion of the upper cylindrical portion 23. An inner peripheral surface 23a of the upper cylindrical portion 23 has a circular shape in a sectional shape orthogonal to the axis O. An upper through-hole 24a passing through the upper bottom portion 24 so as to be centered on the axis O is formed in the upper bottom portion 24. An annular convex portion 24b that projects from a surface of the upper bottom portion 24 facing downward so as to have an annular shape centered on the axis O is formed around the upper through-hole 24a. An upper flange 23b is provided in a lower end of the upper cylindrical portion 23 so as to protrude from an outer peripheral surface of the upper cylindrical portion 23 toward the outer peripheral side thereof.

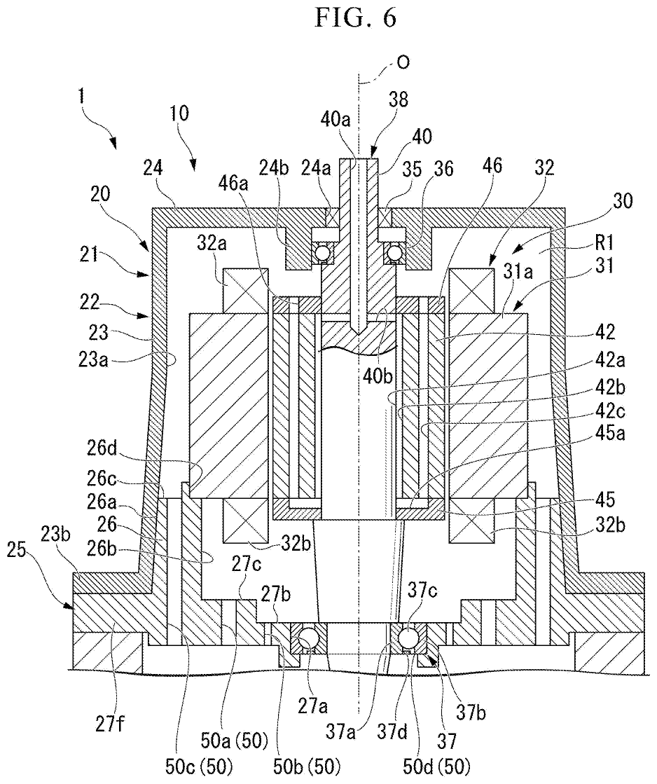

The lower casing 25 has a bottomed cylindrical shape having a cylindrical lower portion 26 that has a cylindrical shape extending in the vertical direction and a lower bottom portion 27 that closes a lower portion of the lower cylindrical portion 26. An outer peripheral surface 26a and an inner peripheral surface 26b of the lower cylindrical portion 26 have a circular shape in a sectional shape orthogonal to the axis O. A lower flange 27f is provided in a lower end of the lower cylindrical portion 26 so as to protrude from the lower cylindrical portion 26 toward the outer peripheral side thereof. As shown in FIG. 6, a lower fitting portion 26d is formed in a radially inner portion and at a corner portion of an upper end of the lower cylindrical portion 26. A plurality of lower fitting portions 26d are formed at intervals in the peripheral direction. A surface of the lower fitting portion 26d facing inward in the radial direction has a shape in which a sectional shape orthogonal to the axis O is a circle centered on the axis O. A surface facing upward of the lower fitting portion 26d has a flat shape orthogonal to the axis O.

A lower through-hole 27a passing through the lower bottom portion 27a so as to be centered on the axis O is formed in the lower bottom portion 27a. A portion around the lower through-hole 27a in the surface facing upward of the lower bottom portion 27 is a first bottom surface 27b having an annular shape and having a flat shape orthogonal to the axis O. A second bottom surface 27c (see FIG. 6) and a third bottom surface 27d (see FIG. 5) are formed around the first bottom surface 27b of the lower bottom portion 27.

As shown in FIG. 6, the second bottom surface 27c is a portion adjacent to the outer peripheral side of the first bottom surface 27b, and is formed to be one step higher than the first bottom surface 27b. The second bottom surface 27c forms a flat shape orthogonal to the axis O. A plurality of second bottom surfaces 27c are formed at intervals in the peripheral direction of the axis O.

As shown in FIG. 5, the third bottom surface 27d is provided adjacent to the outer peripheral side of the first bottom surface 27b similarly to the second bottom surface 27c and adjacent to the second bottom surface 27c in the peripheral direction. The third bottom surface 27d is formed to be one step higher than the second bottom surface 27c. A plurality of third bottom surfaces 27d arc formed at intervals in the peripheral direction of the axis O. In the present embodiment, the plurality of second bottom surfaces 27c and the plurality of third bottom surfaces 27d are alternately provided in the peripheral direction. An inner peripheral surface 26b of the lower cylindrical portion 26 is connected to an outer peripheral side of the second bottom surface 27c and the third bottom surface 27d.

As shown in FIG. 5, an electric motor-side accommodating recess 27 is formed in a portion of a surface facing downward of the lower bottom portion 27 in a peripheral-direction position corresponding to the third bottom surface 27d so as to recess upward from the lower surface of the lower bottom portion 27. A plurality of the electric motor-side accommodating recesses 27e are formed at intervals in the peripheral direction so as to correspond to the third bottom surface 27d.

The lower cylindrical portion 26 is fitted to the upper cylindrical portion 23 so as to be inserted from below. The outer peripheral surface 26a of the lower cylindrical portion 26 is fitted onto the inner peripheral surface 23a of the upper cylindrical portion 23. The upper flange 23b and the lower flange 27f are in contact with each other over the peripheral direction. As a result, the lower cylindrical portion 26 and the upper cylindrical portion 23 are integrally fixed to each other. A space inside the electric motor casing 21 formed by the lower cylindrical portion 26 and the upper cylindrical portion 23 is a first accommodating space R1.

### <Stator>

The stator 30 is provided with a stator core 31 and a coil 32.

The stator core 31 is constituted by stacking a plurality of electromagnetic steel plates in the vertical direction, and includes a core main body 31a and a core convex portion 31b.

The core main body 31a is constituted by a yoke having a cylindrical shape centered on the axis O and teeth formed at intervals with each other in the peripheral direction of the yoke so as to project from an inner peripheral surface of the yoke.

The core convex portion 31b is formed so as to project from the outer peripheral surface of the core main body 31a. A plurality of core convex portions 31b are provided at intervals in the peripheral direction. The core convex portion 31b extends over the entire vertical direction of the core main body 31a.

A plurality of coils 32 are provided to correspond to each of the teeth, and are wound around each of the teeth. As a result, the plurality of coils 32 are provided at intervals in the peripheral direction.

A portion of each coil 32 projecting upward from the stator core 31 is an upper coil end 32a. A portion of each coil 32 projecting downward from the stator core 31 is a lower coil end 32b. As the winding constituting the coil 32, for example, a rectangular winding, a sectional shape of which has a quadrangular shape, is used.

In the present embodiment, the stator core 31 in the stator 30 is fitted on the upper casing 22 and the lower casing 25 of the electric motor casing 21. That is, as shown in FIG. 5, the end portion on the outer peripheral side of the core convex portion 31b in the stator core 31 is fitted onto the inner peripheral surface 23a of the upper cylindrical portion 23 in the upper casing 23. On the other hand, as shown in FIG. 6, an end portion on the outer peripheral side in the lower end of the core main body 31a in the stator core 31 is fitted onto the lower fitting portion 26d of the lower cylindrical portion 26 in the lower casing 25.

Further, in the present embodiment, as shown in FIG. 5, a bolt insertion hole (not shown) penetrating in the vertical direction is formed in the core convex portion 31b of the stator core 31. A bolt 33 is inserted into the bolt insertion hole from above. A lower end of the bolt 33 is fixed to a bolt fixing hole 26e formed in an upper-end surface 26c in the lower cylindrical portion 26 of the lower casing 25. As a result, the stator core 31 is fixed and integrated to the lower casing 25.

### <Rotor>

As shown in FIGS. 5 and 6, the rotor 38 includes a rotary shaft 40, a rotor core 42, a lower end plate 45, and an upper end plate 46.

### <Rotary Shaft>

The rotary shaft 40 is a rod-shaped member extending along the axis O. The rotary shaft 40 is disposed so as to penetrate an inside of the stator 30 in the vertical direction inside the casing. An upper end of the rotary shaft 40 projects upward the electric motor casing 21 through the upper through-hole 24a in the upper bottom portion 24 in the upper casing 22. The upper end of the rotary shaft 40 may be accommodated in the electric motor casing 21.

An upper seal 35 is provided between an inner peripheral surface of the upper through-hole 24a of the upper bottom portion 24 and an outer peripheral surface of the rotary shaft 40. As a result, liquid tightness in the upper end inside the electric motor casing 21 is secured.

An upper bearing 36 having an annular shape centered on the axis O is provided on an inner peripheral surface of the annular convex portion 24b in the upper bottom portion 24. The rotary shaft 40 is vertically inserted into the upper bearing 36, and an upper portion of the rotary shaft 40 is supported by the upper bearing 36 so as to be rotatable about the axis O.

A lower bearing 37 having an annular shape around the axis O is provided on an inner peripheral surface of the lower through-hole 27a in the lower bottom portion 27. The rotary shaft 40 is vertically inserted into the lower bearing 37, and the lower portion of the rotary shaft 40 is supported by the lower bearing 37 so as to be rotatable about the axis O.

A center hole 40a extending downward from the upper end of the rotary shaft 40 and a radial hole 40b extending from the center hole 40a to the outer peripheral surface of the rotary shaft 40 are formed in the rotary shaft 40.

The center hole 40a does not extend over the entire vertical direction of the rotary shaft 40, but extends from the upper end of the rotary shaft 40 to a middle way toward the lower end of the rotary shaft. As a result, the rotary shaft 40 has a hollow structure in a portion where the center hole 40a is formed from the upper end to the lower end, and the remaining portion on the lower side is a solid structure.

The radial hole 40b extends in the radial direction so that an extending direction thereof is aligned with the direction orthogonal to the axis O. A radially inner end portion of the radial hole 40b communicates with the lower portion of the center hole 40a. A radially outer end portion of the radial hole 40b opens into the outer peripheral surface of the rotary shaft 40. A plurality of radial holes 40b are formed at intervals in the peripheral direction.

### <Rotor Core>

The rotor core 42 has a cylindrical shape centered on the axis O, and an inner peripheral surface 42a of the rotor core is fitted on the outer peripheral surface of the rotary shaft 40 from an outside thereof. An upper end of the rotor core 42 fitted on the rotary shaft 40 from the outside thereof is a position in the vertical direction corresponding to the lower end of the center hole 40a. An outer peripheral surface of the rotor core 42 has a cylindrical surface shape centered on the axis O and faces the inner peripheral surface of the stator 30. The rotor core 42 is constituted by stacking a plurality of electromagnetic steel plates in the vertical direction.

On the inner peripheral surface 42a of the rotor core 42, a plurality of inner axial-direction flow paths 42b having a groove shape extending over the entire axial O direction are formed at intervals in the peripheral direction. In a portion on an outer peripheral side of the inner axial-direction flow path 42b in an inside of the rotor core 42, an outer axial-direction flow path 42c extending over the entire axial O direction is formed.

A plurality of permanent magnets (not shown) are embedded in the rotor core 42 at intervals in the peripheral direction.

### <Lower End Plate>

The lower end plate 45 is a disc-like member extending in a direction orthogonal to the axis O and having a circular outer shape centered on the axis O. The lower end plate 45 is fixed to the rotor core 42 so as to be stacked from below the rotor core 42.

A connection flow path 45a extending in the radial direction is formed on an upper surface of the lower end plate 45. A plurality of connection flow paths 45a are formed at intervals in the peripheral direction. The connection flow path 45a connects the inner axial-direction flow path 42b and the outer axial-direction flow path 42c of the rotor core 42 in the radial direction.

### <Upper End Plate>

The upper end plate 46 is a disk-shaped member extending in a direction orthogonal to the axis O and having a circular outer shape centered on the axis O similarly to the lower end plate 45. The upper portion end plate 46 is fixed to the rotor core 42 so as to be stacked from above the rotor core 42. The upper end plate 46 closes the inner axial-direction flow path 42b in the rotor core 42 from above. A plurality of discharge holes 46a penetrating in the vertical direction are formed in the upper end plate 46 at intervals in the peripheral direction. Each of the discharge holes 46a communicates with the outer axial-direction flow path 42c in the rotor core 42.

As a result, a cooling flow path in which the lubricating oil flows in the order of the central hole 40a, the radial hole 40b, the inner axial-direction flow path 42b, the connection flow path 45a, the outer axial-direction flow path 42c, and the discharge hole 46a is formed in the rotor 38.

### <Communication Hole>

As shown in FIG. 6, the electric motor casing 21 has a communication hole 50 that communicates the first accommodating space R1 in the electric motor casing 21 to a lower side thereof.

In the present embodiment, the communication hole 50 is formed as a main oil drain hole 50a, an auxiliary oil drain hole 50b, an outer peripheral-side oil drain hole 50c, and a bearing oil drain hole 50d.

The main oil drain hole 50a is formed so as to open into the second bottom surface 27c in the lower bottom portion 27 of the lower casing 25, and vertically passes through the lower bottom portion 27. A plurality of main oil drain holes 50a are formed at intervals in the peripheral direction so as to correspond to each of the second bottom surfaces 27c.

The auxiliary oil drain hole 50b is formed so as to open into the first bottom surface 27d in the lower bottom portion 27 of the lower casing 25, and vertically passes through the lower bottom portion 27. A plurality of auxiliary oil drain holes 50b are formed at intervals in the peripheral direction. The flow path sectional area of the auxiliary oil drain hole 50b, which is a cross-sectional area orthogonal to the axis O, is smaller than the flow path sectional area of the main oil drain hole 50a.

An upper end of the outer peripheral-side oil drain hole 50c is opened into the upper end face 26c of the lower cylindrical portion 26 and the outer peripheral-side oil drain hole 50c vertically passes through the lower cylindrical portion 26. A plurality of outer peripheral-side oil drain holes 50c are formed at intervals in the peripheral direction. The plurality of outer peripheral-side oil drain holes 50c are formed at intervals in the peripheral direction so as to avoid the bolt fixing holes 26e for fixing the stator core 31. The outer peripheral-side oil drain hole 50c may have a slit shape in which the peripheral direction is a longitudinal direction.

The bearing oil drain hole 50d is formed in the lower bearings 37. As shown in FIG. 6, the lower bearing 37 includes an inner ring 37a, an outer ring 37b, a rolling body 37c, and a bearing shield 37d.

The inner ring 37a is an annular member, and an inner peripheral surface thereof is fixed to the outer peripheral surface of the rotary shaft 40. The outer ring 37b is an annular member provided on the outer peripheral side of the inner ring 37a so as to be spaced apart therefrom, and the outer peripheral surface of the outer ring 37b is fixed to the inner peripheral surface of the lower through-hole 27a of the lower bottom portion 27. The rolling body 37c has a spherical shape, and a plurality of rolling bodies 37c is arranged in the peripheral direction so as to be interposed between the inner ring 37a and the outer ring 37b. The bearing shield 37d is an annular member fixed to a lower end of the outer peripheral surface of the inner ring 37a. The bearing shield 37d has a plate shape having a plate thickness in the vertical direction. A clearance is formed over the peripheral direction between an outer peripheral end of the bearing shield 37d and the inner peripheral surface of the outer ring 37b. The clearance is a bearing oil drain hole 50d. An opening area of the bearing oil drain hole 50d is smaller than the flow path sectional area of the auxiliary oil drain hole 50b.

The heights of upper ends of the inner ring 37a and the outer ring 37b of the lower bearing 37 are flush with the first bottom surface 27b. Therefore, the height of the opening at the upper end between the inner ring 37a and the outer ring 37b in the lower bearing 37 is the same as the height in the upper end of the auxiliary oil drain hole 50b. In addition, the height of the upper end of the auxiliary oil drain hole 50b may be lower than the upper end of the lower bearing 37. That is, the auxiliary oil drain hole 50b may be opened at a portion of the upper end of the lower bearing 37 on a bottom surface of the electric motor casing 21 or lower thereof

### <Speed Reducer>

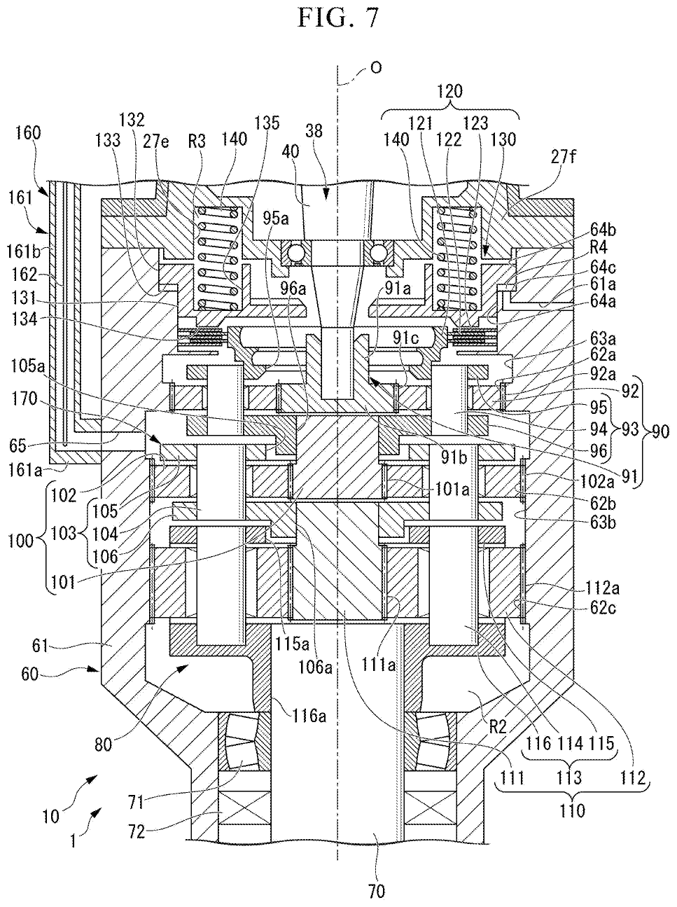

Next, the speed reducer 60 will be described with reference to FIG. 7. The speed reducer 60 includes a speed reducer casing 61, an output shaft 70, a transmission portion 80, and a brake mechanism 120.

### <Speed Reducer Casing>

The speed reducer casing 61 has a cylindrical shape extending along the axis O and opening upward and downward. The upper end of the speed reducer casing 61 abuts the lower flange 27f of the lower casing 25 in the electric motor casing 21 over the peripheral direction. The speed reducer casing 61 is integrally fixed to the lower flange 27f via bolts (not shown) or the like. An upper opening of the speed reducer casing 61 is closed by the lower casing 25 of the electric motor casing 21.

### <Output Shaft>

The output shaft 70 has a rod shape extending along the axis O. A rotation of the output shaft 70 becomes an output of the rotary drive system 1. An upper portion of the output shaft 70 is disposed in the speed reducer casing 61 and a lower portion of the output shaft 70 is disposed so as to project downward from the speed reducer casing 61. An output shaft bearing 71 for rotatably supporting the output shaft 70 about the axis O is provided on a lower portion of an inner peripheral surface of the speed reducer casing 61. As the output shaft bearing 71, for example, a self-aligning roller bearing is used. A lower portion projecting downward from the speed reducer casing 61 in the output shaft 70 is connected to the swing pinion 223.

On the inner peripheral surface of the speed reducer casing 61, further below the output shaft bearing 71, a lower seal 72 for scaling an annular space between the inner peripheral surface of the speed reducer casing 61 and an outer peripheral surface of the output shaft 70 is provided. A space in the speed reducer casing 61 closed from below by the lower seal 72 is defined as a second accommodating space R2. The lower portion of the rotary shaft 40 projecting downward from the electric motor casing 21 is positioned at an upper portion of the second accommodating space R2.

### <Transmission Portion>

The transmission portion 80 is provided in the second accommodating space R2 in the speed reducer casing 61. The transmission unit 80 has a function in which the rotational power of the rotary shaft 40 is input, the rotational speed thereof is reduced and is transmitted to the output shaft 70.

The transmission portion 80 is constituted by a plurality of stages of planetary gear mechanisms that sequentially decelerate the number of revolutions from the rotary shaft 40 to the output shaft 70. As the plurality of planetary gear mechanisms, in the present embodiment, three planetary gear mechanisms that are the first stage planetary gear mechanism 90, the second stage planetary gear mechanism 100, and the third stage planetary gear mechanism 110 are provided.

### <First Stage Planetary Gear Mechanism>

The first stage planetary gear mechanism 90 is a planetary gear mechanism of the first stage. The first stage planetary gear mechanism 90 includes a first stage transmission shaft 91, a first stage planetary gear 92, and a first stage carrier 93.

The first stage transmission shaft 91 includes a fitting cylindrical portion 91a and a disk portion 91b. The fitting cylindrical portion 91a has a cylindrical shape centered on the axis O, and the lower end thereof is closed. The fitting cylindrical portion 91a is fitted from an outside thereof to the lower portion of the rotary shaft 40 from the lower end thereof. As a result, the fitting cylindrical portion 91a is rotatable about the axis O integrally with the rotary shaft 40. The disk portion 91b protrudes from the lower portion of an outer peripheral surface of the fitting cylindrical portion 91a to the outer peripheral side. The disk portion 91b has a disc shape centered on the axis O. First stage sun gear teeth 91c, which are outer gear teeth centered on the axis O, are formed on an outer peripheral surface of the disk portion 91b.

The first stage planetary gear 92 is a gear that has a disc shape, and the first stage planetary gear teeth 92a are formed on an outer peripheral surface thereof. A plurality of first stage planetary gears 92 are provided at intervals in the peripheral direction around the first stage transmission shaft 91. The first stage planetary gear teeth 92a of each first stage planetary gear 92 are engaged with the first stage sun gear teeth 91c of the corresponding first stage transmission shaft 91. Vertical positions of the first stage planetary gears 92 are the same as each other.

Here, at a portion corresponding to an arrangement portion of the first planetary gear teeth 92 in an inner peripheral surface of the speed reducer casing 61, first stage inner gear teeth 62a in which a first stage inner gear tooth 62a is formed over the entire peripheral direction of the inner peripheral surface of the speed reducer casing 21 is formed on the first inner peripheral surface 63a of the speed reducer casing 61. The first inner peripheral surface 63a has a circular shape in a sectional shape orthogonal to the axis O. The first stage planetary gear teeth 92a of the first stage planetary gears 92 mesh with the first stage sun gear teeth 91c and also mesh with the first stage inner gear teeth 62a.

The first stage carrier 93 is a member that supports the first stage planetary gear 92 so as to be rotatable and be capable of revolving around the axis O of the first stage transmission shaft 91. The first stage carrier 93 includes a first stage carrier shaft 94, a first stage upper plate portion 95, and a first stage lower plate portion 96.

A plurality of first stage carrier shafts 94 are provided so as to correspond to the respective first stage planetary gears 92. The first stage carrier shaft 94 passes through the center of each first stage planetary gear 92 in the vertical direction and supports the first stage planetary gear 92 so as to be rotatable.

The first stage upper plate portion 95 has a disc shape centered on the axis O. The first stage upper plate portion 95 is disposed above each of the first stage planetary gears 92 so as to face the first stage planetary gears 92 from above. A first stage insertion hole 95a through which the rotary shaft 40 and the first stage transmission shaft 91 are inserted in the vertical direction is formed in the center of the first stage upper plate portion 95.

The first stage lower plate portion 96 has a disc shape centered on the axis O. The first stage upper plate portion 95 is disposed below each of the first stage planetary gears 92 so as to face the first stage planetary gears 92. A first stage connecting hole 96a passing through in the vertical direction is formed in the center of the first stage lower plate portion 96.

An upper end of each first stage carrier shaft 94 is fixed to the first stage upper plate portion 95 and a lower end thereof is fixed to the first stage lower plate portion 96. Accordingly, each first stage planetary gear 92 is supported by the first stage carrier 93 so as to be sandwiched between the first stage upper plate portion 95 and the first stage lower plate portion 96 from the vertical direction.

### <Second Stage Planetary Gear Mechanism>

The second stage planetary gear mechanism 100 is a planetary gear mechanism in the middle stage. The second stage planetary gear mechanism 100 includes a second stage transmission shaft 101, a second stage planetary gear 102, and a second stage carrier 103. The second stage transmission shaft 101 is a shaft extending with the axis O of the rotary shaft 40 as the center below the first stage transmission shaft 91. An upper end of the second stage transmission shaft 101 is spaced apart from the lower end of the first stage transmission shaft 91. As a result, the second stage transmission shaft 101 is relatively rotatable about the axis O with respect to the first stage transmission shaft 91. In addition, the upper end of the second stage transmission shaft 101 and the lower end of the first stage transmission shaft 91 may be configured to be in sliding contact with each other, or a low-friction sliding contact member may be interposed therebetween.

An upper portion of an outer peripheral surface of the second stage transmission shaft 101 is connected to the first stage connection hole 96a of the first stage lower plate portion 96 of the first stage carrier 93 in the first stage planetary gear mechanism 90. Thus, the second stage transmission shaft 101 rotates about the axis O integrally with the first stage carrier 93. The second stage transmission shaft 101 may be, for example, spline-fitted, to the first stage connection hole 96a of the first stage lower plate portion 96 of the first stage carrier 93.

The second stage sun gear teeth 101a as outer gear teeth with the axis O as the center are formed on a lower portion of the outer peripheral surface of the second stage transmission shaft 101.

The second stage planetary gear 102 is a gear having a disc shape, and the second stage planetary gear teeth 102a are formed on the outer peripheral surface thereof. A plurality of second stage planetary gears 102 are provided at intervals in the peripheral direction around the second stage transmission shaft 101. The second stage planetary gear teeth 102a of each of the second stage planetary gears 102 mesh with the second stage sun gear teeth 101a of the corresponding second stage transmission shaft 101. Positions in the vertical direction of the second stage planetary gears 102 are the same as each other.

The second stage inner gear teeth 62b are formed over the entire peripheral area of the inner peripheral surface of the speed reducer casing 61, in portions corresponding to the positions where the second stage planetary gears 102 are disposed on the inner peripheral surface of the speed reducer casing 61. The second inner gear teeth 62b are formed on the second inner peripheral surface 63b of the speed reducer casing 61. The second inner peripheral surface 63b has a circular shape in a sectional shape orthogonal to the axis O, and has an inner diameter larger than that of the first inner peripheral surface 63a.

The second stage planetary gear teeth 102a of the second stage planetary gear 102 mesh with the second stage sun gear teeth 101a and also mesh with the second stage inner gear teeth 62b.

The second stage carrier 103 is a member that supports the second stage planetary gear 102 so as to be rotatable and be capable of revolving around the axis O of the second stage transmission shaft 101. The second stage carrier 103 includes a second stage carrier shaft 104, a second stage upper plate portion 105, and a second stage lower plate portion 106.

A plurality of second stage carrier shafts 104 are provided so as to correspond to the respective second stage planetary gears 102. The second stage carrier shaft 104 passes through the center of each second stage planetary gear 102 in the vertical direction and supports the second stage planetary gear 102 so as to be rotatable.

The second stage upper plate portion 105 has a disc shape centered on the axis O. The second stage upper plate portion 105 is disposed above each second stage planetary gear 102 so as to face the second stage planetary gears 102 from above. A second stage insertion hole 105a through which the second stage transmission shaft 101 is inserted in the vertical direction is formed in the center of the second stage upper plate portion 105. In the present embodiment, part of the first stage lower plate portion 96 of the first stage carrier 93 is disposed in the second stage insertion hole 105a.

The second stage lower plate portion 106 has a disc shape centered on the axis O. The second stage lower plate portion 106 is disposed below each of the second stage planetary gears 102 so as to face the second stage planetary gears 102 from below. A second stage connecting hole 106a passing through in the vertical direction is formed in the center of the second stage lower plate portion 106.

An upper end of each second stage carrier shaft 104 is fixed to the second stage upper plate portion 105 and a lower end thereof fixed to the second stage lower plate portion 106. Accordingly, each second stage planetary gear 102 is supported by the second stage carrier 103 so as to be sandwiched by the second stage upper plate portion 105 and the second stage lower plate portion 106 from the vertical direction.

### <Third Stage Planetary Gear Mechanism>

The third stage planetary gear mechanism 110 is a planetary gear mechanism of the final stage. The third stage planetary gear mechanism 110 includes a third stage transmission shaft 111, a third stage planetary gear 112, and a third stage carrier 113.

The third stage transmission shaft 111 is an axis extending with the axis O of the rotary shaft 40 as the center below the second stage transmission shaft 101. The upper end of the third stage transmission shaft 111 is spaced apart from the lower end of the second stage transmission shaft 101. As a result, the third stage transmission shaft 111 is relatively rotatable about the axis O with respect to the second stage transmission shaft 101. The upper end of the third stage transmission shaft 111 and the lower end of the second stage transmission shaft 101 may be configured to be in sliding contact with each other, or a low-friction sliding contact member may be interposed therebetween.

The lower end of the third stage transmission shaft 111 is opposed to the upper end of the output shaft 70 so as to be spaced apart from the upper end of the output shaft 62. The third stage transmission shaft 111 and the output shaft 70 are relatively rotatable to each other about the axis O. The lower end of the third stage transmission shaft 111 and the upper end of the output shaft 70 may be configured to be in sliding contact with each other, or a low-friction sliding member having low friction may be interposed therebetween.

The upper portion of an outer peripheral surface of the third stage transmission shaft 111 is connected to the second stage connection hole 106a of a lower plate portion of the second stage carrier 103 in the second stage planetary gear mechanism 100. As a result, the third stage transmission shaft 111 rotates about the axis O integrally with the second stage carrier 103. The third stage transmission shaft 111 may be, for example, spline-fitted to the second stage connection hole 106a of the lower plate portion of the second stage carrier 103.

The third stage sun gear teeth 111a as outer gear teeth centered on the axis O are formed on a lower portion in the outer peripheral surface of the third stage transmission shaft 111.

The third stage planetary gear 112 is a gear that has a disc shape, and the third stage planetary gear teeth 112a are formed on the outer peripheral surface thereof. A plurality of third stage planetary gears 112 are provided at intervals in the peripheral direction around the third stage transmission shaft 111. The third stage planetary gear teeth 112a of each of the third stage planetary gears 112 mesh with the third stage sun gear teeth 111a of the corresponding third stage transmission shaft 111. Positions in the vertical direction of the third stage planetary gears 112 are the same as each other.

The second stage inner gear teeth 62c are formed over the entire peripheral area of the inner peripheral surface of the speed reducer casing 61, in portions corresponding to the positions where the third stage planetary gears 112 are disposed on the inner peripheral surface of the speed reducer casing 61. The third inner gear teeth 62c are formed on the second inner surface 63b of the speed reducer casing 61 as similar to the second inner gear teeth 62b. The third stage planetary gear teeth 112a of the third stage planetary gear 112 mesh with the third stage sun gear teeth 111a and also mesh with the third stage inner gear teeth 62c.

The third stage carrier 113 is a member that supports the third stage planetary gear 112 so as to be rotatable and capable of revolving around the axis O of the third stage transmission shaft 111. The third stage carrier 113 includes a third stage carrier shaft 114, a third stage upper plate portion 115, and a third stage lower plate portion 116.

A plurality of third stage carrier shafts 114 are provided so as to correspond to the respective third stage planetary gears 112. The third stage carrier shaft 114 passes through the center of each third stage planetary gear 112 in the vertical direction and supports the third stage planetary gear 112 so as to be rotatable.

The third stage upper plate portion 115 has a disc shape centered on the axis O. The third stage upper plate portion 115 is disposed above each of the third stage planetary gears 112 so as to face the third stage planetary gears 112 from above. A third stage insertion hole 115a through which the third stage transmission shaft 111 is inserted in the vertical direction is formed in the center of the third stage upper plate portion 115. In the present embodiment, part of the second stage lower plate portion 106 of the second stage carrier 103 is disposed in the third stage insertion hole 115a.

The third stage lower plate portion 116 has a disc shape centered on the axis O. The third stage upper plate portion 115 is disposed below each of the third stage planetary gears 112 so as to face the third stage planetary gears 112 from below. A third stage connecting hole 116a passing through in the vertical direction is formed in the center of the third stage lower plate portion 116. The third stage connection hole 116a is connected to an upper portion of the outer peripheral surface of the output shaft 70. The third stage connection hole 116a and the outer peripheral surface of the output shaft 70 may be spline-fitted. As a result, the third stage carrier 113 and the output shaft 70 are integrally rotated about the axis O.

An upper end of each third stage carrier shaft 114 is fixed to the third stage upper plate portion 115 and a lower end portion thereof is fixed to the third stage lower plate portion 116. Accordingly, each third stage planetary gear 112 is supported by the third stage carrier 113 so as to be sandwiched by the third stage upper plate portion 115 and the third stage lower plate portion 116 from the vertical direction.

### <Brake Mechanism>

As shown in FIGS. 3 and 7, the brake mechanism 120 is disposed above the first stage planetary gear mechanism 90 in the speed reducer casing 61.

As shown in FIG. 7, the brake mechanism 120 includes a disk support portion 121, a brake disk 122, a brake plate 123, a brake piston 130, and a brake spring 140.

The disk support portion 121 is a member having a cylindrical shape centered on the axis O. The lower end of the disk support portion 121 is integrally fixed to the first stage upper plate portion 95 of the first stage carrier 93 in the first stage planetary gear mechanism 90 over the peripheral direction. On the inner peripheral side of the disk support portion 121, a lower portion of the rotary shaft 40 and a portion of the first stage transmission shaft 91 are positioned.

The brake disk 122 is an annular member, and a plurality of brake disks 122 are arranged at intervals in the vertical direction so as to protrude from an outer peripheral surface of the disk support portion 121. The brake disc 122 has a plate shape in which the vertical direction is the thickness direction.

The brake plate 123 is an annular member, and a plurality of brake plates 123 are arranged at intervals in the vertical direction so as to protrude from the inner peripheral surface of the speed reducer casing 61. In the present embodiment, the brake plate 123 is provided so as to protrude from the first sliding contact-inner peripheral surface 64a on the inner peripheral surface of the speed reducer casing 61. The plurality of brake plates 123 and the plurality of brake disks 122 are alternately arranged in the order of the brake plate 123 and the brake disk 122 from the upper side to the lower side. The brake plate 123 and the brake disk 122 are capable of being brought into contact with each other.

The brake piston 130 is a member having an annular shape centered on the axis O, and is disposed so as to be movable in the vertical direction above the brake plate 123. The brake piston 130 is disposed so as to face from below the lower bottom portion 27 of the lower casing 25 in the electric motor casing 21. A lower portion of an outer peripheral surface of the brake piston 130 is a first sliding contact-outer peripheral surface 131.

The first sliding contact-outer peripheral surface 131 of the brake piston 130 is slidable in the vertical direction with respect to the first sliding contact-inner peripheral surface 64a of the speed reducer casing 61.

An upper portion on the outer peripheral surface of the brake piston 130 is a second sliding contact-outer peripheral surface 132. An outer diameter of the second sliding contact-outer peripheral surface 132 is larger than that of the first sliding contact-outer peripheral surface 131. The second sliding contact-outer peripheral surface 132 of the brake piston 130 is slidable in the axial O direction with respect to the second sliding contact-inner peripheral surface 64b of the speed reducer casing 61. An inner diameter of the second sliding contact-inner peripheral surface 64b of the speed reducer casing 61 is larger than that of the first sliding contact-inner peripheral surface 64a.

A step portion between the first sliding contact-outer peripheral surface 131 and the second sliding contact-outer peripheral surface 132 in the brake piston 130 has a flat shape orthogonal to the axis O and faces downward, and is a piston-side step surface 133 having an annular shape.

The step portion between the first sliding contact-inner peripheral surface 64a and the second sliding contact-inner peripheral surface 64b in the speed reducer casing 61 has a flat shape orthogonal to the axis O faces upward, and is a casing-side step surface 64c having an annular shape.

The piston-side step surface 133 and the casing-side step surface 64c face in the vertical direction, and are changed between a state of being in contact with each other and a state of being separated from each other in accordance with a movement in the vertical direction of the brake piston 130. An annular space defined by separating the piston-side step surface 133 and the casing-side step surface 64c from each other is a hydraulic pressure supply space R4.

A hydraulic pressure supply hole 61a that is capable of supplying hydraulic pressure to the hydraulic pressure supply space R4 from the outside is formed in the speed reducer casing 61. Hydraulic pressure generated by a hydraulic pump is supplied to the hydraulic pressure supply hole 61a.

An annular lower surface in the brake piston 130 is a plate contact surface 134. The plate abutting surface 134 comes into contact with the brake plate 123 from above over the entire peripheral direction.

A plurality of piston-side accommodating recesses 135 which are recessed from above and formed at intervals from each other in the peripheral direction are formed on an annular upper surface in the brake piston 130. Positions in the peripheral direction of the piston-side accommodating recesses 135 corresponds to the respective positions in the peripheral direction of the motor-side accommodating recesses 27e formed in the lower casing 25 of the electric motor casing 21.

The brake spring 140 is accommodated in each spring accommodating portion R3 defined by the piston-side accommodating recess 135 and the motor-side accommodating recess 27e which are opposed to each other in the vertical direction. The brake spring 140 is a coil spring which extends in a direction parallel to the axis O, and is accommodated in the spring accommodating portion R3 in a compressed state.

### <Liquid Level of Lubricating Oil>

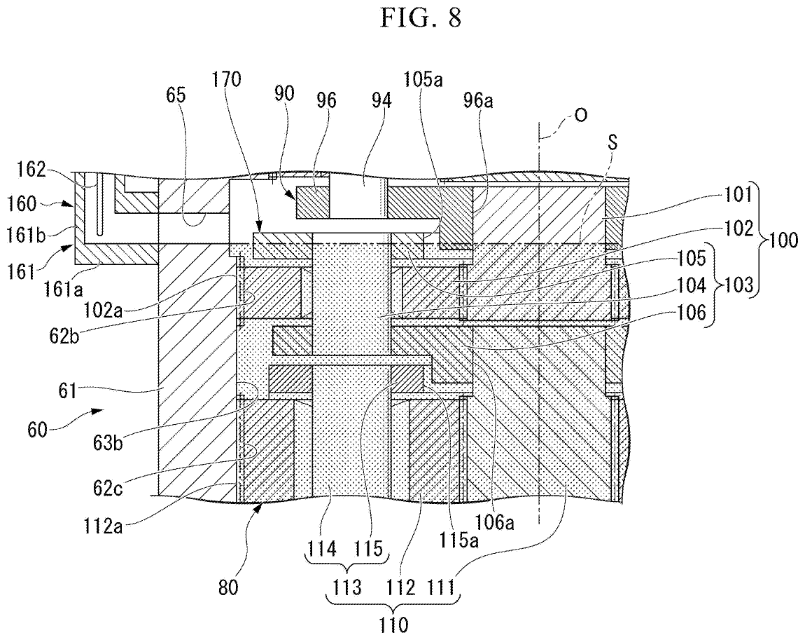

As shown in FIG. 8, lubricating oil is stored in the second accommodating space R2 in the speed reducer casing 61. That is, the second accommodating space R2 is used as a tank for storing lubricating oil. The liquid level S of the stored tank is set to a predetermined height in a state where the axis O is oriented in the vertical direction and the rotary drive system 1 is stopped (a state in which the liquid level S is stable). In the present embodiment, the height of the liquid level S of the lubricating oil is set to be lower than the first stage planetary gear 92 of the first stage planetary gear mechanism 90 which is the first stage and higher than the second stage planetary gear 102 of the second stage planetary gear 100 which is the middle stage.

Even in a state where the lubricating oil is circulated by the lubricating oil-circulating unit 150 described later, the height of the liquid level S of the lubricating oil in the second accommodating space R2 maintains the above relationship.

### <Oil Inspection Unit>

As shown in FIG. 7, the oil inspection unit 160 is used to detect a liquid level S of lubricating oil stored in the second accommodating space R2 in the speed reducer casing 61 as a tank. In the present embodiment, the oil inspection unit 160 is provided only in the speed reducer 60 among the electric motor 20 and the speed reducer 60.

The oil inspection unit 160 includes an oil inspection pipe 161 and an oil inspection rod 162.

The oil inspection pipe 161 includes a horizontal pipe 161a having a tubular shape and extending radially outward from the outer peripheral surface of the speed reducer casing 61, and a vertical pipe 161b having a tubular shape and extending upward from the horizontal pipe 161a and communicating with the horizontal pipe 161a.

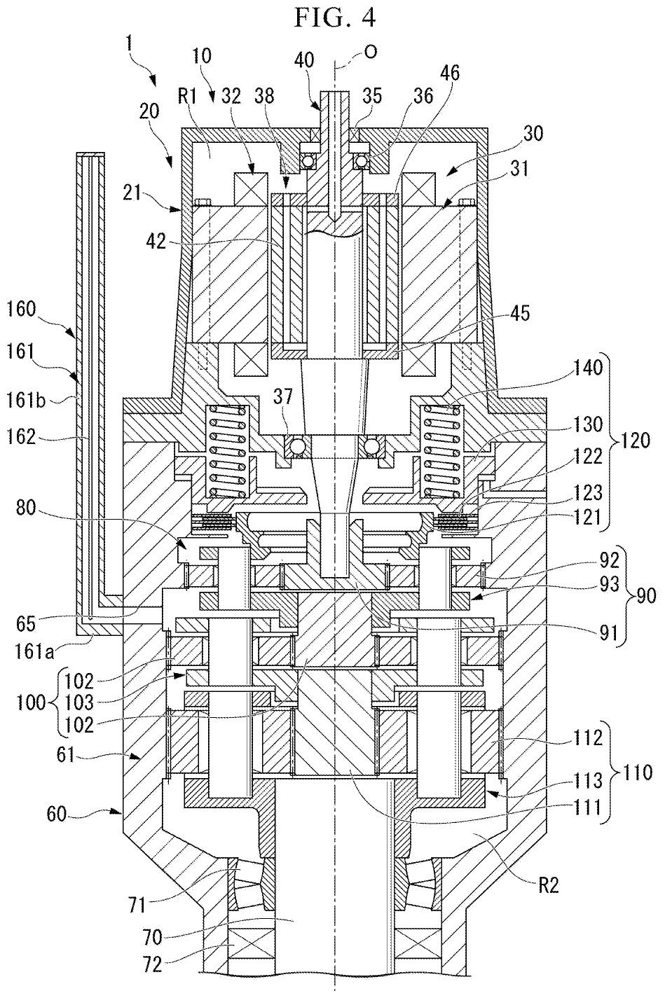

As shown in FIGS. 4 and 7, an oil inspection hole 65 passing through the speed reducer 60 in the horizontal direction (the direction orthogonal to the axis O) is formed at a predetermined height position in the speed reducer casing 61. In the present embodiment, the oil inspection hole 65 is open into the second inner peripheral surface 63b of the speed reducer casing 61. The horizontal pipe 161a in the oil inspection pipe 161 is provided so as to communicate with the oil inspection hole 65. That is, a space inside the oil inspection hole 65 is continuous so as to maintain the height of a lower end of the oil inspection hole 65 in the space inside the horizontal pipe 161a.

The oil inspection rod 162 is a rod-shaped member inserted from above the vertical pipe 161b. In the state in which the oil inspection rod 162 is accommodated in the vertical pipe 161b, the lower end of the oil inspection rod 162 is in contact with a bottom surface of the space inside the horizontal pipe 161a, or is opposed to the bottom surface thereof so as to have a clearance.

When lubricating oil is stored in the reducer casing 61 by an appropriate amount, the lower end of the oil inspection rod 162 comes into contact with the lubricating oil. On the other hand, when the amount of lubricating oil is insufficient, the lower end of the oil inspection rod 162 is dried without coming into contact with the lubricating oil. The operation of the oil inspection is performed by extracting the oil inspection rod 162 from the vertical pipe 161b and visually observing an adhering state of the lubricating oil on the lower end of the oil inspection rod 162. The liquid level S of the lubricating oil stored in the second accommodating space R2 as a tank is set to a height at which lubricating oil can enter into the inside of the oil inspection pipe. Therefore, the height of the liquid level S is set to be substantially the same as or slightly higher than the lower end of an opening of the oil inspection hole 65.

### <Height of Oil Inspection Hole>

As shown in FIG. 7, the height of the oil inspection hole 65 of the speed reducer casing 61 is lower than the first stage planetary gear 92 of the first stage planetary gear mechanism 90, which is the first stage, and is higher than the second stage planetary gear 102 of the second stage planetary gear mechanism 100, which is the middle stage.

More specifically, the height of the lower end of the opening of the oil inspection hole 65 is lower than the first stage planetary gear 92 of the first stage planetary gear mechanism 90, which is the first stage, and is higher than the second stage planetary gear 102 of the second stage planetary gear mechanism 100, which is the middle stage. In the present embodiment, the height of an upper end of the opening of the oil inspection hole 65 is also positioned below the first stage planetary gear 92 of the first stage planetary gear mechanism 90. The upper end of the oil inspection hole 65 may be positioned above the lower end of the first stage planetary gear 92.

### <Throttle Portion>

As shown in FIG. 7, the second stage upper plate portion 105 and the second stage lower plate portion 106 in the second stage carrier 103 of the second stage planetary gear mechanism 100 are respectively opposed to the second inner peripheral surface 63b in the speed reducer casing 61 over the peripheral direction. An outer diameter of an outer peripheral surface of the second stage upper plate portion 105 is larger than an outer diameter of an outer peripheral surface of the second stage lower plate portion 106. Thus, a clearance between the outer peripheral surface of the second stage upper plate portion 105 and the second inner peripheral surface 63b of the speed reducer casing 61 is smaller than a clearance between an inner peripheral surface of the second stage lower plate portion 106 and the second inner peripheral surface 63b of the speed reducer casing 61. Moreover, the outer peripheral surface of the second upper plate portion 105 is opposed to the oil inspection hole 65 in the horizontal direction. In the present embodiment, a lower surface of the second stage upper plate portion 105 is positioned below the lower end of the opening of the oil inspection hole 65, and an upper surface of the second stage upper plate portion 105 is positioned between the lower end and the upper end of the oil inspection hole 65. The second upper plate portion 105 functions as a throttle portion 170 that reduces the amount of lubricating oil that flows into the oil inspection pipe 161.

### <Lubricating Oil-Circulating Unit>

As shown in FIG. 3, the lubricating oil-circulating unit 150 supplies lubricating oil into the first accommodating space R1 in the electric motor casing 21, and supplies again the lubricating oil recovered from an inside of the second accommodating space R2 in the speed reducer casing 61 to the first accommodating space R1.

The lubricating oil-circulating unit 150 includes a lubricating oil flow path 151, a lubricating oil pump 152, a cooling portion 153, and a strainer 154.

The lubricating oil flow path 151 is a flow path formed by a flow path forming member such as a pipe provided outside the rotary drive device 10. A first end of the lubricating oil flow path 151, which is an end portion on the upstream side of the lubricating oil flow path, is connected to the second accommodating space R2 in the speed reducer casing 61. In the present embodiment, the first end of the lubricating oil flow path 151 is connected to a portion between the output shaft bearing 71 and the lower seal 72 in the second accommodating space R2.

A second end of the lubricating oil flow path 151, which is an end portion at the downstream side of the lubricating oil flow path, is connected to an opening of the center hole 40a in the upper end of the rotary shaft 40. The second end of the lubricating oil flow path 151 is connected to the first accommodating space R1 in the electric motor casing 21 via a cooling flow path in the rotor 38.

The lubricating oil pump 152 is provided in the middle of the lubricating oil flow path 151, and pumps lubricating oil from the first end toward the second end of the lubricating oil flow path 151, that is, from the second accommodating space R2 side toward the first accommodating space R1 side.

The cooling portion 153 is provided at a portion on the downstream side of the lubricating oil pump 152 in the lubricating oil flow path 151. The cooling portion 153 cools the lubricating oil flowing through the lubricating oil flow path 151 by exchanging heat with the external atmosphere.

The strainer 154 is provided at a portion on the upstream side of the lubricating oil pump 152 in the lubricating oil flow path 151. The strainer 154 has a filter for removing dirt and dust from lubricating oil passing through the lubricating oil flow path 151. The strainer 154 is preferably provided with a magnetic filter for removing iron powder generated from, for example, the gear teeth of the speed reducer 60.

### Operation and Effects

When the rotary drive system 1 is stopped, that is, the stoppage of the hydraulic excavator 200, hydraulic pressure is not generated by the hydraulic pump 238, and the hydraulic pressure is not supplied to a hydraulic pressure supply space R4 in the brake mechanism 120. Therefore, the brake piston 130 of the brake mechanism 120 is in a state of being pressed downward by the brake spring 140. As a result, the brake piston 130 presses the brake plate 123, whereby the brake plate 60 and the brake disk 20 are in a state of being braked by the frictional force between the brake plate 123 and the brake disk 122. Lubricating oil is stored up to the liquid level S in the second accommodating space R2 of the speed reducer casing 61.

On the other hand, when the engine 236 of the hydraulic excavator 200 is operated and hydraulic pressure is generated by the hydraulic pump 238, some of the hydraulic pressure is reduced to a pilot pressure by means of a pressure-reducing means such as a hydraulic throttle. When an operator of the hydraulic excavator 200 performs an unlocking operation of the lock lever, the lock switch, or the like, which enables the operation of the work equipment 232 and the upper swing body 230, the hydraulic pressure reduced in pressure is supplied to the hydraulic pressure supply space R4 based on the operation. The hydraulic pressure causes the brake piston 130 to move upward against the pressure force of the brake spring 140. As a result, the brake is released and the speed reducer 60 and the electric motor 20 are in a rotatable state.

AC power is supplied to each coil 32 of the stator 30 of the electric motor 20 via the inverter 239, and the permanent magnets follow the rotating magnetic field generated by the coils 32, so that the rotor 38 rotates with respect to the stator 30. The rotation of the rotary shaft 40 of the rotor 38 is reduced in speed through the transmission portion 80 in the speed reducer 60, and is transmitted to the output shaft 70. In the present embodiment, reducing speed is sequentially performed via three stages of the planetary gear mechanisms. Swing motion of the upper swing body 230 is carried out by the rotation of the output shaft 70.

When the upper swing body 230 swings, the electric motor 20 is driven with high torque. Therefore, the rotor core 42 and the permanent magnets reach a high temperature due to iron loss in the rotor core 42 and eddy current loss in the permanent magnets. At the same time, the stator 30 reaches a high temperature due to copper loss at the coil 32 and iron loss at the stator core 31. When the stator 30 reaches a high temperature, the rotor core 42 reaches a higher temperature by the radiant heat of the stator 30. Therefore, the cooling oil is supplied into the electric motor 20 by the lubricating oil-circulating unit 150.

When the lubricating oil pump 152 of the lubricating oil-circulating unit 150 is operated, some of the lubricating oil stored in the second accommodating space R2 is supplied from the upper end into the center hole 40a of the rotary shaft 40 in the rotor 38 of the electric motor 20 through the lubricating oil flow path 151. The lubricating oil supplied to the center hole 40a of the rotary shaft 40 cools the rotor core 42 and permanent magnets in the process of flowing through the radial hole 40b, the inner axial-direction flow path 42b, the connection flow path 45a, and the outer axial-direction flow path 42c. The lubricating oil discharged through the discharge hole 46a is spread outward in the radial direction by the centrifugal force caused by the rotation of the rotor 38. As a result, lubricating oil is supplied to the stator core 31 and the coil 32 of the stator 30 and cooling of the stator 30 is achieved. Thereafter, the lubricating oil which has fallen from the stator 30 is discharged from an inside of the electric motor 20 through the communication hole 50 formed in the electric motor casing 21. When the rotary drive system 1 is operated, the lubricating oil is discharged to the lower side of the electric motor 20 mainly through the main oil drain hole 50a and the outer peripheral side oil drain hole 50c.

The lubricating oil is discharged to the lower side of the electric motor 20 through the communication hole 50, so that the lubricating oil is supplied to the second accommodating space R2 in the speed reducer casing 61. The lubricating oil supplied to the second accommodating space R2 so as to fall down from the communication hole 50 lubricates each of the gear teeth of the first stage planetary gear mechanism 90, and then returned to the lubricating oil stored in the second accommodating space R2. The second stage planetary gear mechanism 100 and the third stage planetary gear mechanism 110 are immersed in the lubricating oil stored in the second accommodating space R2, and thus the lubricity of each of the gear teeth is secured.

As described above, according to the rotary drive system 1 of the present embodiment, the lubricating oil supplied into the electric motor casing 21 is introduced into the speed reducer casing 61 through the communication hole 50. The lubricating oil merges with the lubricating oil stored in the speed reducer casing 61 as a tank. It is possible to supply some of the stored lubricating oil to the electric motor 20 again. As a result, it is possible to consistently carry out the cooling of the rotor 38 and the stator 30 of the electric motor 20 and the lubricating of the transmission portion 80 in the speed reducer 60 via the lubricating oil-circulating unit 150.

Therefore, it is not necessary to form a tank for storing lubricating oil in the electric motor 20. Therefore, it is possible to prevent the electric motor 20 from becoming larger in size, and the entire rotary drive system 1 can be made compact.

Further, it is not necessary to separately manage the amount of oil of the speed reducer 60 and the electric motor 20. When the electric motor 20 and the speed reducer 60 are each provided with a tank for storing lubricating oil or cooling oil, it is necessary to provide separate oil inspection units 160 for managing the respective liquid levels S. Further, it is necessary to separately manage the properties of the lubricating oil and the properties of the cooling oil, thus making maintenance cumbersome.

In the present embodiment, since the lubricating oil is stored only in the speed reducer 60 side, it is possible to manage the liquid level S of the lubricating oil only by providing one oil inspection unit 160. Therefore, it is possible to reduce the production cost as compared with the case where the oil inspection unit 160 is provided in each of the speed reducer 60 and the electric motor 20. Further, since only the properties of one lubricating oil need to be managed, it is possible to improve maintenance performance.

Here, the first stage transmission shaft 91 and the first stage planetary gear 92 directly connected to the rotary shaft 40 of the speed reducer 60 are rotated at high speed in accordance with the rotational speed of the rotary shaft 40. Therefore, in the case where the first stage transmission shaft 91 and the first stage planetary gear 92 are immersed in lubricating oil, stirring loss increases and efficiency is lowered. Further, the variation in the liquid level S of the lubricating oil also increases.

In contrast, in the present embodiment, the liquid level S of the lubricating oil stored in the second accommodating space R2 in the speed reducer casing 61 is positioned below the first stage planetary gear 92 which rotates at the highest speed and the first stage sun gear teeth 91c of the first stage transmission shaft 91. Therefore, it is possible to suppress an increase in stirring loss.

On the other hand, the second stage planetary gear 102 and the second stage sun gear 101a, which have been reduced in rotational speed by one stage, are positioned below the liquid level S of the stored lubricating oil. Therefore, since each rotational speed of the second stage planetary gear 102 and the second stage sun gear 101a is smaller than that of the first stage planetary gear mechanism 90, there is no significant increase in stirring loss even when the lubricating oil is immersed in the lubricating oil. Accordingly, it is possible to appropriately perform lubrication of the second stage planetary gear mechanism 100 and the third stage planetary gear mechanism 110 while suppressing stirring loss.

In addition, since lubrication in the first stage planetary gear 92 is carried out by the lubricating oil flowing down through the communication hole 50 of the electric motor casing 21, inadvertent deterioration in lubricity at the first stage does not occur.

The height position of the oil inspection hole 65 in the oil inspection unit 160 corresponds to the height of the liquid level S of the stored lubricating oil to be managed.

In the present embodiment, since the height position of the oil inspection hole 65 is lower than the first stage planetary gear 92 and above the second stage planetary gear 102, it is possible to appropriately lubricate the planetary gear mechanism while reducing stirring loss.

Here, when the hydraulic excavator 200 is positioned at an inclined surface, the liquid level S of the lubricating oil stored in the second accommodating space R2 may fluctuate. Also, when the rotary drive system 1 is rotated, the stored lubricating oil is affected by centrifugal force, and as a result, the liquid level S may fluctuate.

In the present embodiment, a throttle portion 170 that suppresses an inflow of lubricating oil to be introduced into the oil inspection hole 65 is formed at a height position corresponding to the oil inspection hole 65. Therefore, it is possible to prevent the lubricating oil from excessively flowing into the oil inspection pipe 161 inadvertently. That is, the throttle portion 170 causes pressure loss to the lubricating oil that is going to flow into the oil inspection pipe 161, and thus, it is possible to suppress an increase of an amount of the inflow. Accordingly, it is possible to stabilize the liquid level S in the oil inspection pipe 161. As a result, for example, it is possible to suppress leakage of the lubricating oil from the oil inspection pipe 161.

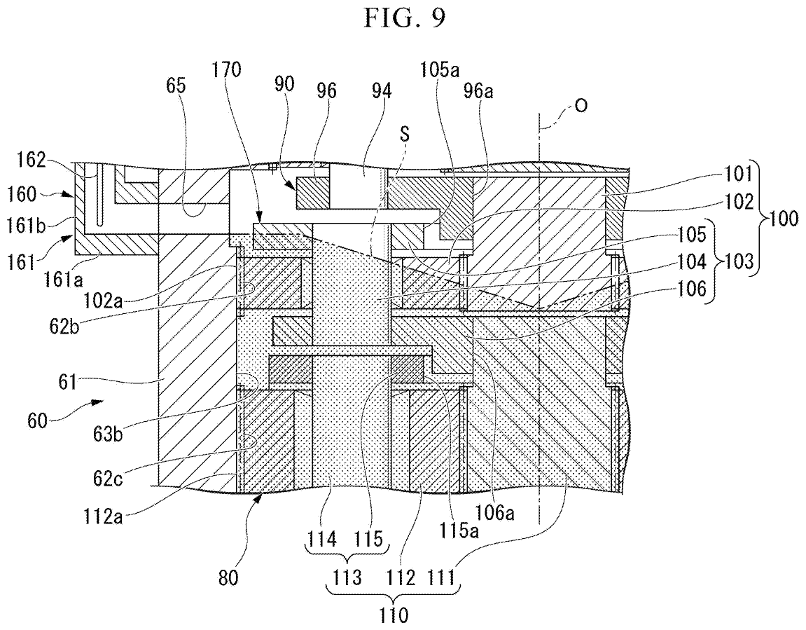

In particular, in the present embodiment, the second stage upper plate portion 105 of the second stage carrier 103 in the second stage planetary gear mechanism 100 is the throttle portion 170. Thus, for example, as shown in FIG. 9, even when the lubricating oil is displaced radially outward due to centrifugal force, it is possible to stabilize the liquid level S in the oil inspection pipe 161 by the throttle portion 170 causing pressure loss to the oil inspection pipe 161, and it is possible to prevent the lubricating oil from inadvertently flowing into the oil inspection pipe 161. Further, since the throttle portion 170 can be configured without providing separate parts, cost reduction can be achieved.

In the present embodiment, as shown in FIG. 6, since the main oil drain hole 50a is opened above the lower bearing 37, it is possible to be in a state of always supplying the lubricating oil introduced into the first accommodating space R1 of the electric motor casing 21 to the lower bearing 37 during operation of the rotary drive system 1. As a result, it is possible to rotate and support stably the rotary shaft 40.

On the other hand, when the operation of the rotary drive system 1 is stopped, it is possible to discharge the lubricating oil remaining in the first accommodating space R1 to the speed reducer 60 side from the bearing oil drain hole 50d formed in the lower bearing 37, and at the same time, it is possible to discharge the lubricating oil to the speed reducer 60 side via the auxiliary oil drain hole 50b. Thus, the lubricating oil is smoothly collected on the speed reducer 60 side without retaining the lubricating oil in the electric motor 20 side at the time of stopping, and it is possible to merge the lubricating oil with the lubricating oil stored in the second accommodating space R2.

### Other Embodiments

Although the embodiment of the present invention has been described above, the present invention is not limited thereto and can be appropriately changed without departing from the technical idea of the present invention.

In the present embodiment, an example has been described in which the transmission portion 80 has a total of three stages, that is, a first stage, a middle stage, and a final stage, of the planetary gear mechanisms, but the present invention is not limited thereto, and may include, for example, only one stage, two stages, four stages or more, of the planetary gear mechanisms. The planetary gear mechanism in the middle stage may be divided into a plurality of stages.

In the embodiment, the liquid level S of the lubricating oil in the second accommodating space R2 is positioned below the first stage planetary gear 92 and above the second stage planetary gear 102, but may be positioned, for example, below the second stage planetary gear 102 and above the third stage planetary gear 112. That is, it is sufficient that the liquid level S is positioned below the first stage planetary gear 92 and above any one of the second and subsequent planetary gears. Accordingly, it is possible to appropriately lubricate the planetary gear having a relatively low rotational speed while reducing stirring loss due to a high rotational speed of the planetary gear.

Similarly, in the embodiment, the height position of the oil inspection pipe 161 is positioned below the first stage planetary gear 92 and above the second stage planetary gear 102; however, the height position may be positioned, for example, below the second stage planetary gear and above the third stage planetary gear 112.

The structure of the rotor 38 is not limited to the present embodiment, and may have other cooling structures.

The throttle portion 170 of the embodiment need not necessarily be provided. In addition, another structure different from the second stage carrier 103 may be provided as the throttle portion.

In the embodiment, although an example in which the present invention is applied to the rotary drive system 1 of the hydraulic excavator 200 as a work machine has been described, the above-described rotary drive system 1 may be applied to a mechanism that swings or rotates part of a different work machine.

### INDUSTRIAL APPLICABILITY

The present invention is applicable to a rotary drive system and a hydraulic excavator using the rotary drive system. According to the present invention, it is possible to achieve reduction in cost while achieving compactness.

### EXPLANATION OF REFERENCE SIGNS

1: Rotary Drive System;
10: Rotary Drive Device;
20: Electric Motor;
21: Electric Motor Casing;
22: Upper Casing;
23: Upper Cylindrical Portion;
23a: Inner Peripheral Surface;
23b: Upper Flange;
24: Upper Bottom Portion;
24a: Upper Through-Hole;
24b: Annular Convex Portion;
25: Lower Casing;
26: Lower Cylindrical Part
26a: Outer Peripheral Surface;
26b: Inner Peripheral Surface;
26c: Upper-end Surface.
26d: Lower Fitting Portion;
26e: Bolt Fixing Hole;
27: Lower Bottom Portion;
27a: Lower Through-Hole;
27b: First Bottom Surface (bottom surface of the electric motor casing);
27c: Second Bottom Surface (bottom surface of the electric motor casing);
27d: Third Bottom Surface (bottom surface of the electric motor casing);
27e: Electric Motor-side Accommodating Recess;
27f: Lower Flange;
30: Stator;
31: Stator Core;
31a: Core Main Body;
31b: Core Convex Portion;
32: Coil;
32a: Upper Coil End;
32b: Lower Coil End;
33: Bolt;
35: Upper Seal;
36: Upper Bearing;
37: Lower Bearing;
37a: Inner Ring;
37b Outer Ring;
37c: Rolling Body;
37d: Bearing Shield;
38: Rotor;
40: Rotary Shaft;
40a: Center Hole;
40b: Radial Hole;
42: Rotor Core;
42a: Inner Peripheral Surface;
42b: Inner Axial-direction Flow Path;
42c: Outer Axial-direction Flow Path;
45: Lower End Plate;
45a: Connection Flow Path;
46: Upper End Plate;
46a: Discharge Hole;
50: Communication Hole;
50a: Main Oil Drain Hole;
50b: Auxiliary Oil Drain Hole;
50c: Outer Peripheral-side Oil Drain Hole;
50d: Bearing Oil Drain Hole;
60: Speed Reducer;
61: Speed Reducer Casing;
61a: Hydraulic Pressure Supply Hole;
62a: First Stage Inner Gear Teeth;
62b: Second Stage Inner Gear Teeth;
62c: Third Stage Inner Gear Teeth;
63a: First Inner Peripheral Surface;
63b: Second Inner Peripheral Surface;
64a: First Sliding Contact-Inner Peripheral Surface;
64b: Second Sliding Contact-Inner Peripheral Surface;
64c: Casing-side Step Surface;
65: Oil Inspection Hole;
70: Output Shaft;
71: Output Shaft Bearing;
72: Lower Seal;
80: Transmission Portion;
90: First Stage Planetary Gear Mechanism;
91: First Stage Transmission Shaft;
91a: Fitting Cylindrical Portion;
91b: Disk Portion;
91c: First Stage Sun Gear Teeth;
92: First Stage Planetary Gear;
92a: First Stage Planetary Gear Teeth;
93: First Stage Carrier;
94: First Stage Carrier Shaft;
95: First Upper Plate Portion;
95a: First Stage Insertion Hole;
96: First Stage Lower Plate Portion;
96a: First Stage Connection Hole;
100: Second Stage Planetary Gear Mechanism;
101: Second Stage Transmission Shaft;
101a: Second Stage Sun Gear Teeth;
102: Second Stage Planetary Gear;
102a: Second Stage Planetary Gear Teeth;
103: Second Stage Carrier (Carrier).
104: Second Stage Carrier Shaft;
105: Second Upper Plate Portion (Upper Plate Portion).
105a: Second Stage Insertion Hole;
106: Second Stage Lower Plate Portion (Lower Plate Portion).
106a: Second Stage Connection Hole;
110: Third Stage Planetary Gear Mechanism;
111: Third Stage Transmission Shaft;
111a: Third Stage Sun Gear Teeth;
112: Third Stage Planetary Gear;
112a: Third Stage Planetary Gear Teeth;
113: Third Stage Carrier;
114: Third Stage Carrier Shaft;
115: Third Stage Upper Plate Portion;
115a: Third Stage Insertion Hole;
116: Third Stage Lower Plate Portion;
116a: Third Stage Connection Hole;
120: Brake Mechanism;
121: Disk Support Portion;
122: Brake Disc;
123: Brake Plate;
130: Brake Piston;
131: First Sliding Contact-Outer Peripheral Surface;
132: Second Sliding Contact-Outer Peripheral Surface;
133: Piston-side Step Surface;
134: Plate Contact Surface;
135: Piston-side Accommodating Recess;
140: Brake Spring;
150: Lubricating Oil-Circulating Unit;
151: Lubricating Oil Flow Path;
152: Lubricating Oil Pump;
153: Cooling Portion;
154: Strainer;
160: Oil Inspection Unit;
161: Oil Inspection Pipe;
161a: Horizontal Pipe;
161b: Vertical Pipe;
162: Oil Inspection Rod;
170: Throttle Portion;
200: Hydraulic Excavator;
211: Crawler Belt;
210: Undercarriage;
220: Swing Circle;
221: Outer Race;
222: Inner Race;
223: Swing Pinion;
230: Upper Swing Body;
231: Cab;
232: Work Equipment;
233: Boom;
234: Arm;
235: Bucket;
236: Engine;
237: Generator Motor;
238: Hydraulic Pump;
239: Inverter;
240: Capacitor;
L: Swing Axis;
O: Axis;
S: Liquid Level;
R1: First Accommodating Space;
R2: Second Accommodating Space;
R3: Spring Accommodating Portion;
R4: Hydraulic Pressure Supply Space

1. A rotary drive system, comprising:
an electric motor including
a rotary shaft provided so as to be rotatable about an axis extending in a vertical direction,
a rotor core fixed to an outer peripheral surface of the rotary shaft,
a stator surrounding the rotor core from the outer peripheral side of the rotor core, and
an electric motor casing forming a first accommodating space that accommodates the rotary shaft, the rotor core and the stator so that a lower portion of the rotary shaft projects downward, and forming a communication hole communicating downward;
a speed reducer including
an output shaft provided so as to be rotatable about the axis below the rotary shaft,
a transmission portion in which a rotation of the rotary shaft is reduced in speed and is transmitted to the output shaft,
a speed reducer casing that accommodates the output shaft and the transmission portion and forms a second accommodating space communicating with the first accommodating space through the communication hole; and
a lubricating oil-circulating unit including
a lubricating oil flow path that connects the first accommodating space and the second accommodating space at an outside, and
a lubricating oil pump that is provided in the lubricating oil flow path and is configured to pump lubricating oil from the second accommodating space side to the first accommodating space side.

2. The rotary drive system according to claim 1,
wherein the transmission portion includes
a plurality of planetary gear mechanisms that sequentially reduce in rotational speed from the rotary shaft to the output shaft,
wherein the lubricating oil is stored in the second accommodating space; and
wherein a liquid level of the lubricating oil in the second accommodating space is positioned below the planetary gear of a first stage planetary gear mechanism of the plurality of planetary gear mechanisms and above the planetary gear of any one of a second and subsequent stage planetary gear mechanisms of the plurality of planetary gear mechanisms.

3. The rotary drive system according to claim 1,
wherein the transmission portion includes
a plurality of planetary gear mechanisms that sequentially reduce in rotational speed from the rotary shaft to the output shaft,
wherein an oil inspection hole passing through in a horizontal direction is formed in the speed reducer casing,
wherein the rotary drive device further comprises an oil inspection unit connected from an outside and is capable of detecting an oil level of the lubricating oil stored in the second accommodating space, and
wherein a height position of the oil inspection hole is positioned below the planetary gear of a first stage planetary gear mechanism of the plurality of planetary gear mechanisms and above the planetary gear of any one of a second and subsequent stage planetary gear mechanisms of the plurality of planetary gear mechanisms.

4. The rotary drive system according to claim 3,
wherein the transmission portion includes
a throttle portion which has a disc shape centered on the axis and an outer peripheral surface of which faces the oil inspection hole from the horizontal direction.

5. The rotary drive system according to claim 4,
wherein the planetary gear mechanism having the planetary gear positioned just below the oil inspection hole includes
a carrier having an upper plate portion and a lower plate portion that are provided so as to sandwich the planetary gear from above and below and to support the planetary gear such that the planetary gear is capable of rotating and revolving,
wherein an outer diameter of the upper plate portion is larger than an outer diameter of the lower plate portion, and
the throttle portion is the upper plate portion.

6. The rotary drive system according to claim 1, further comprising:
a lower bearing that is provided at a lower portion of the electric motor casing and rotatably supports the rotary shaft about the axis,
wherein the communication hole includes
a main oil drain hole that is opened at a position above an upper end of the lower bearing on a bottom surface of the electric motor casing.

7. The rotary drive system according to claim 6,
wherein the communication hole includes:
an auxiliary oil drain hole that is opened at a position at the upper end of the lower bearing or below thereof on the bottom surface of the electric motor casing and that has an opening area smaller than that of the main oil drain hole.

8. A hydraulic excavator, comprising:
an undercarriage;
an upper swing body provided on the undercarriage; and
the rotary drive system according to claim 1 that swings the upper swing body about the axis with respect to the undercarriage.

9. The rotary drive system according to claim 2,
wherein the transmission portion includes
a plurality of planetary gear mechanisms that sequentially reduce in rotational speed from the rotary shaft to the output shaft,
wherein an oil inspection hole passing through in a horizontal direction is formed in the speed reducer casing,
wherein the rotary drive device further comprises an oil inspection unit connected from an outside and is capable of detecting an oil level of the lubricating oil stored in the second accommodating space, and
wherein a height position of the oil inspection hole is positioned below the planetary gear of a first stage planetary gear mechanism of the plurality of planetary gear mechanisms and above the planetary gear of any one of a second and subsequent stage planetary gear mechanisms of the plurality of planetary gear mechanisms.

10. The rotary drive system according to claim 9,
wherein the transmission portion includes
a throttle portion which has a disc shape centered on the axis and an outer peripheral surface of which faces the oil inspection hole from the horizontal direction.

11. The rotary drive system according to claim 10,
wherein the planetary gear mechanism having the planetary gear positioned just below the oil inspection hole includes
a carrier having an upper plate portion and a lower plate portion that are provided so as to sandwich the planetary gear from above and below and to support the planetary gear such that the planetary gear is capable of rotating and revolving,
wherein an outer diameter of the upper plate portion is larger than an outer diameter of the lower plate portion, and
the throttle portion is the upper plate portion.

12. The rotary drive system according to claim 2, further comprising:
a lower bearing that is provided at a lower portion of the electric motor casing and rotatably supports the rotary shaft about the axis,
wherein the communication hole includes
a main oil drain hole that is opened at a position above an upper end of the lower bearing on a bottom surface of the electric motor casing.

13. The rotary drive system according to claim 3, further comprising:
a lower bearing that is provided at a lower portion of the electric motor casing and rotatably supports the rotary shaft about the axis,
wherein the communication hole includes
a main oil drain hole that is opened at a position above an upper end of the lower bearing on a bottom surface of the electric motor casing.

14. The rotary drive system according to claim 4, further comprising:
a lower bearing that is provided at a lower portion of the electric motor casing and rotatably supports the rotary shaft about the axis,
wherein the communication hole includes
a main oil drain hole that is opened at a position above an upper end of the lower bearing on a bottom surface of the electric motor casing.

15. The rotary drive system according to claim 5, further comprising:
a lower bearing that is provided at a lower portion of the electric motor casing and rotatably supports the rotary shaft about the axis,
wherein the communication hole includes
a main oil drain hole that is opened at a position above an upper end of the lower bearing on a bottom surface of the electric motor casing.

16. A hydraulic excavator, comprising:
an undercarriage;
an upper swing body provided on the undercarriage; and
the rotary drive system according to claim 2 that swings the upper swing body about the axis with respect to the undercarriage.

17. A hydraulic excavator, comprising:
an undercarriage;
an upper swing body provided on the undercarriage; and
the rotary drive system according to claim 3 that swings the upper swing body about the axis with respect to the undercarriage.

18. A hydraulic excavator, comprising:
an undercarriage;
an upper swing body provided on the undercarriage; and
the rotary drive system according to claim 4 that swings the upper swing body about the axis with respect to the undercarriage.

19. A hydraulic excavator, comprising:
an undercarriage;
an upper swing body provided on the undercarriage; and
the rotary drive system according to claim 5 that swings the upper swing body about the axis with respect to the undercarriage.

20. A hydraulic excavator, comprising:
an undercarriage;
an upper swing body provided on the undercarriage; and
the rotary drive system according to claim 6 that swings the upper swing body about the axis with respect to the undercarriage.
